(19) United States
(12) Patent Application Publication
(10) Pub. No.: US 2013/0143978 A1
(43) Pub. Date: Jun. 6, 2013

(54) UV CURABLE COATING COMPOSITION WITH IMPROVED SCRATCH RESISTANCE

(71) Applicant: Gia Huynh-Ba, Hockessin, DE (US)

(72) Inventor: Gia Huynh-Ba, Hockessin, DE (US)

(73) Assignee: E I DU PONT DE NEMOURS AND COMPANY, Wilmington, DE (US)

(21) Appl. No.: 13/813,999

(22) PCT Filed: Aug. 17, 2011
(86) PCT No.: PCT/US2011/048084

§ 371 Date: Feb. 4, 2013

Related U.S. Application Data
(60) Provisional application No. 61/374,389, filed on Aug. 17, 2010.
(60) Provisional application No. 61/374,387, filed on Aug. 17, 2010.
(60) Provisional application No. 61/374,384, filed on Aug. 17, 2010.

(51) Int. Cl. C09D 133/14; B05D 3/06

(52) U.S. Cl. CPC C09D 133/14; B05D 3/06
USPC 522/18; 524/555; 427/487

(57) ABSTRACT

Disclosed is a coating composition that when dried and cured, provides a coating composition having excellent scratch and mar resistance. The coating composition is cures upon exposure to ultraviolet radiation. The coating composition comprises a film forming binder that is a polymer having poly(trimethylene ether) repeat units and in the range of from 1 to 20 ethylenically unsaturated double bonds. The coating composition is especially useful as a clearcoat composition in the automotive industry.

### CROSS REFERENCE TO RELATED APPLICATION

This application claims priority under 35 U.S.C. §119 from U.S. Provisional Application Ser. No. 61/374,384, filed Aug. 17, 2010.

### FIELD OF THE DISCLOSURE

The present disclosure is directed to a coating composition that is curable using ultraviolet (UV) radiation, condensation polymerization reactions or a combination of both UV radiation and condensation polymerization reactions. This disclosure is also directed toward a substrate coated by a dried and cured layer of the coating composition and methods for applying the coating composition.

### BACKGROUND OF DISCLOSURE

The repair and refinishing of damaged coatings is an important industry, especially in the automotive field. Once the gross damage to a vehicle has been repaired, one or more layers of coating compositions can be applied to protect the substrate and to match the color and gloss of the substrate prior to damage.

The applied layers can include one or more primer compositions, basecoat compositions, clearcoat compositions, glossy topcoat compositions or any combination thereof. Each of these coating compositions can be cured using one of two general methods. The first method comprises the formation of a chemical network by the condensation reaction of one functional group with another to form a covalent bond. Typical condensation reactions can include the reaction of an isocyanate functional group with, for example, one or more of a hydroxyl and/or amine groups. Other functional groups that can be useful for these condensation reactions are known in the art and can also be used. The second method comprises the addition polymerization of ethylenically unsaturated double bonds by irradiation, optionally in the presence of a photoinitiator to form a chemical network.

Several coating compositions are known that can combine both methods of curing in one composition, for example, WO 09/39137, published Mar. 26, 2009. The coatings produced in this application do not have excellent scratch and mar resistance. In another example, U.S. Pat. No. 6,815,501, published Oct. 9, 2003, requires the use of both hydroxyl functional polyester urethanes having olefinic double bonds and polyisocyanate, crosslinking agents and have a limited pot life. It would be desirable to have a coating composition that has both mono and dual cure capabilities while providing a long pot life and excellent properties, such as, scratch and mar resistance.

### STATEMENT OF THE DISCLOSURE

The present disclosure is directed to a coating composition comprising a film forming binder wherein the film forming binder comprises component (A) wherein the component (A) is a polymer having at least one poly(trimethylene ether) repeat unit and in the range of from 1 to 20 ethylenically unsaturated double bonds. The present disclosure also relates to a method of applying the coating composition to a substrate and to substrates coated with a dried and cured layer of the coating composition. The coating composition is especially useful as a clearcoat composition and, in some embodiments, can be used as a clearcoat composition to repair a damaged finish on an automobile.

### DETAILED DESCRIPTION

The features and advantages of the present disclosure will be more readily understood, by those of ordinary skill in the art, from reading the following detailed description. It is to be appreciated that certain features of the disclosure, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including every value between the minimum and maximum values.

As used herein:

The term poly(trimethylene ether) means a polymer having at least five consecutive trimethylene ether repeat units of the formula —OCH₂CH₂CH₂— or a polyether having greater than 50 percent by weight trimethylene ether repeat units. The polymer can, in theory, contain tens of thousands of such units, however, for this disclosure, the upper limit will be 2,000 repeating trimethylene ether units. In some embodiments, the trimethylene ether repeat unit can be the only polyether repeat unit in the polymer. In other embodiments, a small portion (generally, less than 50 percent by weight) of the repeat units may be ethylene ether (—OCH₂CH₂—) and/or 1,2-propylene ether (—OCH₂CH(CF₁₃)—) and/or 1,4-butylene ether (—OCH₂CH₂CH₂CH₂—) repeat units.

The term “(meth)acrylate” means acrylate and/or methacrylate.

The terms “radiation”, “actinic radiation” or “irradiation” means electromagnetic energy or the application thereof that can cause, in the presence of a photoinitiator, polymerization of monomers that have ethylenically unsaturated double bonds, such as, for example, acrylic or methacrylic double bonds. Sources of actinic radiation may be natural sunlight or artificial radiation sources. Examples of actinic radiation include, but are not limited to. UV-A radiation, which falls within the wavelength range of from 320 nanometers (nm) to 400 nm; UV-8 radiation, which is radiation having a wavelength falling in the range of from 280 nm to 320 nm; UV-C radiation, which is radiation having a wavelength falling in the range of from 100 nm to 280 nm; and UV-visible, radiation, which is radiation having a wavelength falling in the range of from 400 nm to 800 nm. Other examples of radiation can include electron-beam, also known as e-beam. Many artificial radiation sources emit a spectrum of radiation that contains UV radiation having wavelengths shorter than 320 nm. Radiation of wavelengths shorter than 320 nm emits high energy and can cause damage to the skin and eyes. Radiation with longer wavelengths, such as UV-A or UV-visible, emit lower energy and are considered safer than radiation with shorter wavelengths, such as UV-C or UV-B.

The phrase “pot mix” refers to a coating composition that comprises a mixture of a crosslinkable component and a crosslinking component. The two components are typically stored in separate containers and mixed just prior to use. The crosslinkable component is usually those components that have a hydroxyl or amine functional group whereas the crosslinking component comprises, for example, isocyanate functional groups.

The phrase “pot life” refers to the length of time that a pot mix can be applied before the viscosity of the mixture rises to the point that it becomes impractical to apply a layer of the coating. In general, the pot life is considered to be the time it takes for the viscosity of the pot mix to double from the initial viscosity, measured just after the pot mix is formed.

As used herein the phrase “divalent radical having both cycloalkyl and linear and/or branched alkyl portions having in the range of from 6 to 20 carbon atoms” means a divalent radical that has at least one cycloalkyl ring and one or more of a linear alkyl group and/or a branched alkyl group.

In some embodiments, the disclosed coating composition comprises a film forming binder wherein the film forming binder comprises or consists essentially of a component (A) wherein the component (A) is a polymer having at least one poly(trimethylene ether) and in the range of from 1 to 20 ethylenically unsaturated double bonds.

In other embodiments, the coating composition comprises a film forming binder wherein the film forming binder comprises or consists essentially of the component (A) and one or more of a component (B) and/or a component (C). Component (B) comprises or consists essentially of one or more molecules having two or more ethylenically unsaturated double bonds such as, for example, poly(meth)acrylates, hexanediol di(meth)acrylate, trimethylol propane tri(meth)acrylate, pentaerythritol tri(meth)acrylate, pentaerythritol tetra(meth)acrylate, dipentaerythritol tetra(meth)acrylate, ester(meth)acrylates, urethane(meth)acrylates or a combination thereof. Many molecules having two or more ethylenically unsaturated groups are commercially available and can include DESMOLUX® (meth)acrylates from Bayer Material Science; various poly(meth)acrylates from Sartorner USA, LLC, and others that are known to those of ordinary skill in the art. Combinations of any the poly(meth)acrylates can be used. Component (C) can comprise or consist essentially of known crosslinking agents such as, for example, polyisocyanates, polycarboxylic acids, polyamines, polyepoxides, compounds having one or more ethylenically unsaturated double bonds and a combination thereof.

Coating compositions containing only component (A) or component (A) and component (B) are generally useful wherein the coating composition can be cured using radiation alone. Component (C) can be added when additional crosslinking is desired or in applications where the application of the radiation cannot reach all portions of the coating composition applied to the substrate due to, for example, intricate part shapes or shaded areas.

In some embodiments, component (A) comprises or consists essentially of the reaction product of a reactant (1) with a reactant (2) to form a molecule having a (1)-(2) or a (1)-(2)-(1) arrangement. The phrase “reaction product” means that when the reactants, for example, reactant (1) and reactant (2), are brought into contact with one another under the appropriate conditions, a new product is created as the result of the formation of one or more covalent bond between the reactants. The covalent bond can be the result of an addition reaction wherein one molecule adds to another without the loss of any part of either of the reactants, such as, for example, the reaction of an isocyanate group with a hydroxyl group to form a urethane bond. The covalent bond can also be the result of a condensation reaction wherein one molecule adds to another with the loss of a portion of one or both of the reactants, such as, for example, the reaction of a carboxylic acid group with a hydroxyl group to form an ester bond with the loss of a molecule of water.

Reactant (1) is H₂C═C(R)CO₂H, H₂C═C(R)CO₂—R¹-E, H₂C═C(R)—R¹-E or a combination thereof, wherein R is H or CH₃; each R¹ is a divalent linear alkyl radical having in the range of from 1 to 20 carbon atoms, a divalent branched alkyl radical having in the range of from 3 to 20 carbon atoms, a divalent cycloalkyl radical having in the range of from 5 to 10 carbon atoms, or a divalent radical having both cycloalkyl and linear and/or branched alkyl portions having in the range of from 6 to 20 carbon atoms;

E is —NCO, —CO₂H, epoxy, hydroxyl or amine. While the carboxylic acid group is noted as one possible functional group for the group E, it can be possible to use derivatives of the carboxylic acid group. For example, acid chlorides or acid halides can be used as well as alkyl esters of carboxylic acids, for example, the methyl or ethyl esters of carboxylic acids. In some embodiments, acryloyl chloride or methacryloyl chloride may be used as reactant (1).

Suitable examples of reactant (1) can include, for example, (meth)acrylic acid, isocyanatoalkyl (meth)acrylate, glycidyl (meth)acrylate, primary aminoalkyl (meth)acrylates, secondary alkyl aminoalkyl (meth)acrylates, hydroxyalkyl (meth)acrylates or combinations thereof. In further embodiments, reactant (1) can include, for example, acrylic acid, methacrylic acid, isocyanatoethyl acrylate, isocyanatoethyl methacrylate, aminoethyl acrylate, aminoethyl methacrylate, t-butylaminoethyl acrylate, t-butylaminoethyl methacrylate, hydroxyethyl acrylate, hydroxyethyl methacrylate, hydroxypropyl acrylate, hydroxylpropyl methacrylate, hydroxybutyl acrylate, hydroxybutyl methacrylate or a combination thereof.

In some embodiments, reactant (2) comprises or consists of a polyether diol having poly(trimethylene ether) repeat units. In other embodiments, reactant (2) comprises or consists of HO(CH₂CH₂CH₂O)ₙH; wherein n is in the range of from 5 to 2,000. In some embodiments, reactant (2) can further include a poly(trimethylene ether) mono alcohol of the formula HO(CH₂CH₂CH₂O)ₙR² wherein R² is a aliphatic radical having in the range of from 1 to 20 carbon atoms.

In some embodiments, component (A) can be the reaction product between reactants (1) and (2) with the final product having (1)-(2) or (1)-(2)-(1) arrangements of the reactants. For example, component (A) can have a (1)-(2)-(1) arrangement. As used herein, this means that 2 equivalents of reactant (1) have reacted with 1 equivalent of reactant (2) to form one embodiment of component (A). One particular embodiment of component (A) can include, for example, the condensation reaction of two equivalents of acrylic acid with one equivalent of the poly(trimethylene ether), HO(CH₂CH₂CH₂O)ₙH, to form a component (A) having a structure (1) according to;

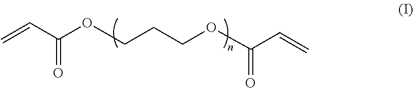

In another embodiment, component (A) can have a (1)-(2) arrangement resulting from the reaction of one equivalent of a reactant (1) with one equivalent of a reactant (2). As an example, reactant (1) can be 2-isocyanatoethyl methacrylate and reactant (2) can be HO(CH₂CH₂CH₂O)ₙH. The resulting component (A) can have a structure according to (II);

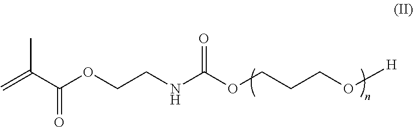

In still further embodiments, component (A) comprises or consists essentially of the reaction product of reactants (1), (2) and a further reactant (3). The reaction between (1), (2) and (3) can be performed so that component (A) is a molecule having an arrangement according to;
[(1)-(2)]ₐ-(3);
(1)ₐ-(3)-(2)ₐ;
[(1)-(2)]ₐ-(3)-(1)_{b};
[(1)-(2)]ₐ-(3)-(2)_{b}; or
(1)ₐ-(3)-(2)-(3)-(1)_{b};
   wherein each a is independently an integer in the range of from 1 to 20 and b is an integer in the range of from 0 to 20. In further embodiments, each a is independently an integer in the range of from 2 to 10 and b is an integer in the range of from 1 to 10. In the above structures, if more than one of a reactant (1) is present, then each reactant (1) can be the same or can be different. In each of the above structures, if more than one of a reactant (2) is present, the each reactant (2) can be the same or different. Also in the above structures, if more than one of a reactant (3) is present, then each reactant (3) can be the same or different. In some embodiments, reactant (3) can be a molecule having at least two functional groups that are reactive with reactants (1) and/or (2). In further embodiments, reactant (3) is a diisocyanate, a polyisocyanate, a dicarboxylic acid, a polycarboxylic acid, a dicarboxylic acid ester, a polycarboxylic acid ester, a diepoxide, a polyepoxide, a polyacrylate having carboxylic acid functional groups, a polyacrylate having isocyanate functional groups or a polyacrylate having epoxy functional groups, in still further embodiments, reactant (3) is hexamethylene diisocyanate, isophorone diisocyanate, the isocyanurate of hexamethylene diisocyanate, the isocyanurate of isophorone diisocyanate or a combination thereof.

Component (A) can have a variety of structures depending upon functional groups present in reactants (1), (2) and (3). The final structures would be further dependent upon the order of addition of the individual reactants, the stoichiometry and the conditions under which the reaction is performed. For example, component (A) can have a [(1)-(2)]ₐ-(3)-(1)_{b} arrangement. Several methods can be used to form a product having this arrangement. In one example, comprising three steps and using a diisocyanate as reactant (3), one equivalent of acrylic acid as reactant (1) can be reacted with one equivalent of a poly(trimethylene ether) diol as reactant (2) to form an acrylic ester having a terminal hydroxyl group. One equivalent of this product can then be reacted with one equivalent of a hexamethylene diisocyanate as reactant (3) to form a product; [(1)-(2)]ₐ-(3), wherein a is equal to 1 and the product has a terminal isocyanate group. In the third step, one equivalent of 2-hydroxyethyl acrylate as a reactant (1) can be added to form the final [(1)-(2)]ₐ-(3)-(1)_{b} product, (III) below, wherein both a and b are equal to 1.

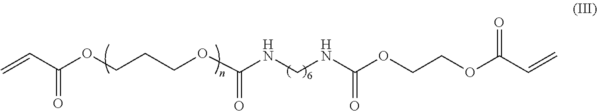

In another embodiment, reactant (3) can be a polyisocyanate, such as, for example, the isocyanurate of 1,6-hexamethylene, diisocyanate isophorone diisocyanate. Isocyanurates diisocyanates typically have three isocyanate groups. Depending on the stoichiometry of reactants (1) and (2), a variety of products can be produced. As an example, using the isocyanurate of 1,6-hexamethylene diisocyanate;

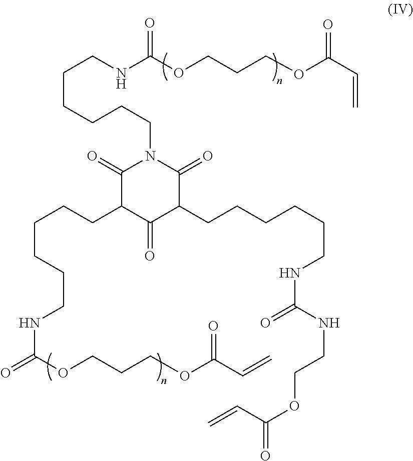

The structure (IV) above is an idealized representation of a [(1)-(2)]₂-(3)-(1) structure wherein the (1)-(2) structure can be formed, for example, by the reaction of one equivalent of acrylic acid with one equivalent of a poly(trimethylene ether) diol to form an intermediate acrylate ester having one hydroxyl group. Two equivalents of this intermediate can then be combined with one equivalent of 2-aminoethyl acrylate and one equivalent of the isocyanurate of a diisocyanate. The structure above represents one possible product out of a number of possible products. One of ordinary skill in the art would understand that other products are possible. For example, a [(1)-(2)]-(3)-(1)₂ arrangement is another possible structure that can be formed.

In another embodiment, the isocyanurate of a diisocyanate may be reacted in such a manner that the final product contains one or more free isocyanate groups. One particular embodiment can be shown as, for example as (V);

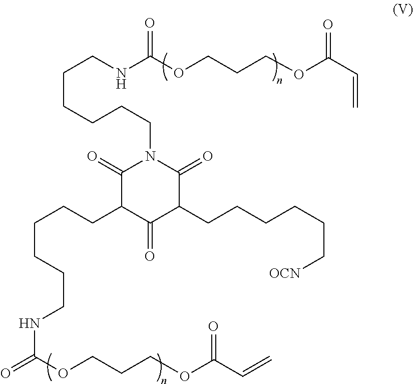

In this example, 1 equivalent of acrylic acid can first be reacted with one equivalent of poly(trimethylene ether) diol to form an intermediate hydroxyl functional acrylic ester. Two equivalents of the intermediate can then be reacted with one equivalent of the isocyanurate of hexamethylene diisocyanate to form a product as above. The above structure is an example of a [1)-(2)]₂-(3) arrangement.

In still further embodiments, component (A) can have a (1)ₐ-(3)-(2)-(3)-(1)_{b} arrangement. Such an arrangement can be depicted by the structure (VI) shown below, wherein both a and b are equal to 1. This example can be produced, for example, by the reaction of one equivalent of a polytrimethylene ether diol with two equivalents of 1,6-hexamethylene diisocyanate to yield an intermediate diurethane material having two free isocyanate groups. One equivalent of the intermediate diurethane can then be reacted with two equivalents of 2-hydroxylethyl acrylate to give the product;

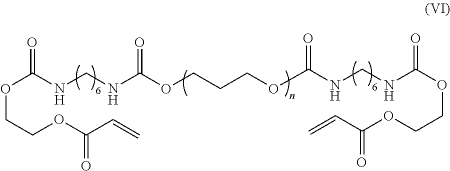

In a further example of component (A), one could react two equivalents of 2-hydroxyethyl methacrylate with one equivalent of the isocyanurate of isophorone diisocyanate to produce an intermediate molecule having two ethylenically unsaturated groups and one free isocyanate group. This intermediate molecule could then be reacted with one equivalent of polytrimethylene ether diol to form, for example a structure according to (VII),

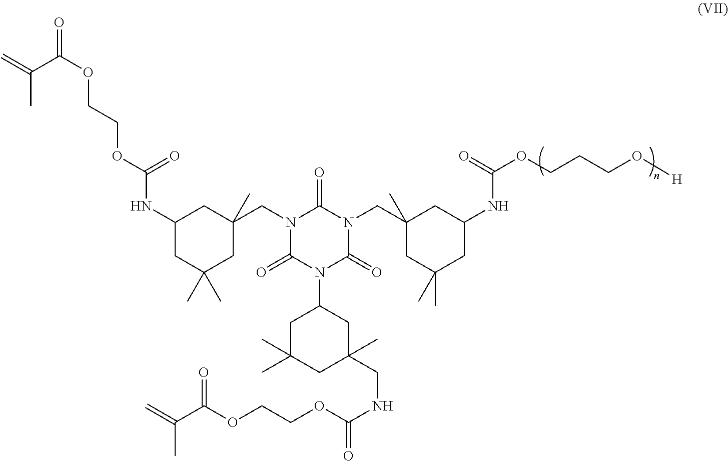

can be produced. In another example, two equivalents of isocyanate functional intermediate per equivalent of polytrimethylene ether diol could be used to produce a component (A) having four ethylenically unsaturated groups and no hydroxyl groups.

In still further embodiments, component (A) can comprise or consist essentially of the reaction product of reactants (1), (2), (3) and a further reactant (4). Reactant (4) can be a molecule having in the range of from 2 to 10 functional groups, wherein at least one of the functional groups is reactive with reactant (2) or (3). Examples of reactant (4) can include many of the same reactants as described for reactant (3), for example, isocyanates, diisocyanates, polyisocyanates, epoxides, diepoxides, and polyepoxides, alcohols, diols, polyols, amines, diamines, polyamines or suitable combinations thereof.

To form the desired coating composition, molecules according to component (A) can be used as the only film forming binder, or, in other embodiments, component (A) can be combined with component (B) and/or component (C). In some embodiments, the film forming binder can comprise or consist essentially of in the range of from 100 percent to 10 percent by weight of component (A), in the range of from 0 percent to 90 percent of component (B) and in the range of from 0 percent to 70 percent by weight of component (C), wherein all percentages by weight are based on the total amount of film forming binder. In other embodiments, the film forming binder can comprise or consist essentially of in the range of from 90 percent to 20 percent by weight of component (A), in the range of from 10 percent to 80 percent of component (B) and in the range of from 0 percent to 70 percent by weight of component (C), wherein all percentages by weight are based on the total amount of film forming binder. In still further embodiments, the film forming binder can comprise or consist essentially of in the range of from 80 percent to 30 percent by weight of component (A), in the range of from 20 percent to 70 percent of component (B) and in the range of from 0 percent to 70 percent by weight of component (C), wherein all percentages by weight are based on the total amount of film forming binder. If component (C) is added, the addition is typically made just prior to the application of the coating composition to the substrate since the crosslinking agent typically can react with one or more of the functional groups that may be present on component (A) and/or (B). The coating composition can also comprise various additives that are common in the art. These can include, for example, photoinitiators, organic solvents, light stabilizers, rheology control agents, pigments, fillers or a combination thereof.

Suitable photoinitiators are known in the art and can include, for example, benzophenone, benzoin, benzoin methyl ether, benzoin n-butyl ether, benzoin isobutyl ether, propiophenone, acetophenone, methylphenylglyoxylate, 1-hydroxycyclohexyl phenyl ketone, 2,2-diethoxyacetophenone, ethylphenylglyoxylate, diphenyl (2,4,6-trimethylbenzoyl)phosphine oxide, phenyl bis-(2,4,6-trimethylbenzoyl)phosphine oxide, phenanthraquinone, azobisisobutyronitrile, hydrogen peroxide, azoisobutyramide and a combination thereof. Suitable photoinitiators are available under the DAROCURE® and IRGACURE® tradenames available from Ciba Specialty Chemicals, Tarrytown, N.Y. Photoinitiators can be used in the range of from 1 to 15 percent by weight, based on the weight of the film forming binder.

Volatile organic solvents can be used as a liquid carrier for the coating composition. Suitable organic solvents can include, for example, acetone, methyl ethyl ketone, methyl isobutyl ketone, methyl amyl ketone, ethyl acetate, butyl acetate, t-butyl acetate, dimethyl carbonate, propyl carbonate, xylene, toluene, glycol ethers, hexane, dimethyl ether or a combination thereof. The amount of organic solvent can vary depending on the application method, environmental conditions and other known factors. Generally, the amount of organic solvent can be in the range of from 10 to 90 percent by weight, based on the total amount of coating composition.

The coating composition can be applied to a variety of substrates including metal, plastic, wood, concrete, and previously coated metal or plastic substrate. The coating composition can be applied to the substrate via spray application, dipping, roller coating, flow coating or brushing. In some embodiments, the method for applying a layer of a coating composition to a substrate can include;
1) applying a layer of the coating composition to the substrate,
2) optionally allowing at least a portion of the organic solvent to flash off; and
3) exposing at least a portion of the applied layer of coating composition to radiation to cure at least a portion of the coating composition.
   In other embodiments, the method can further comprise the step of heating the applied layer of coating composition to a temperature in the range of from 20° C. to about 100° C. to cure any crosslinkable and crosslinking components that may be present. The step of heating can be done before step 3), concurrent with step 3) or after step 3). The optional flash step can be performed at ambient temperature or at elevated temperatures in the range of from 20° C. to about 100° C.

The present disclosure also relates to a substrate coated by a dried and cured layer of the coating composition. As used herein, the phrase “dried and cured” means that at least a portion (greater than 50%) of the organic solvent has evaporated from the applied layer of coating composition and that curing of the film forming binder has begun. The disclosed coating composition is particularly useful for use as a clearcoat composition in the finishing of substrates, especially automotive substrates. The coating composition can dry and cure completely after exposure to radiation and provides a cured coating which is resistant to scratch and mar.

### EXAMPLES

The following commercially available ingredients were used in the examples. Unless otherwise noted, all ingredients are available from the Aldrich Chemical Company, Milwaukee, Wis.

DESMOLUX® VPLS 2337 acrylic isocyanate, DESMOPHEN® VPLS polyester, DESMOLUX® 2513 urethane acrylate, DESMOLUX® XP 2654 urethane acrylate and DESMOLUX® U680H urethane acrylate are available from Bayer Material Science, Pittsburgh, Pa.

SR-351 HP® and SR-355® acrylic monomers are available from Sartomer USA, LLC., Exton, Pa.

DAROCUR® TPO photoinitiator, IRGACURE® 184 photoinitiator, TINUVIN® 400 UV absorber, TINUVIN® 292 light stabilizer are available from Ciba Specialty Chemicals, Tarrytown, N.Y.

BYK® 333 polysiloxane is available from BYK USA Inc., Wallingford, Conn.

PO3G is Poly(trimethylene ether) diol having a Tg of −75° C. and GEN IV® clearcoat are both available from DuPont, Wilmington, Del.

Preparation of Comparative Diol A

A caprolactone oligomer was prepared by reacting-caprolactone monomer and 1,4-cyclohexanedimethanol in a 3/1 molar ratio. A 5-liter round bottom flask was fitted with a thermocouple, a heating source, a mechanical stirrer, and a reflux condenser. 29.6 parts by weight of 1,4-cyclohexanedimethanol 70.3 parts by weight of epsilon-caprolactone, and 0.1 parts by weight of a 10% of solution of dibutyl tin dilaurate in xylene were added to the round bottom flask and were heated to 140° C. and held at a temperature in the range of from 135° C. to 140° C. for 4 hours. Gas chromatography showed that all the caprolactone had been consumed. The oligomer had a weight average molecular weight of about 486, a Tg of about −70° C., and a polydispersity of about 1.1.

Preparation of Film Forming Binder 1

3.7 parts by weight of VPLS 2337® acrylic isocyanate and 6.3 parts by weight of PO3G (molecular weight 900) were stirred in 5.95 parts by weight of butyl acetate. 0.05 parts by weight of a 2% solution of dibutyl tin dilaurate in butyl acetate was added. The solution was clear and a visual assessment of the viscosity was good. The solution was stirred in the dark overnight. After stirring overnight, a visual assessment of the viscosity noted that the mixture was thick.

Preparation of Film Forming Binder 2

2.7 parts by weight of VPLS 2337® acrylic isocyanate and 7.3 parts by weight of PO3G (molecular weight 1400) were stirred in 5.95 parts by weight of butyl acetate. 0.05 parts by weight of a 2% solution of dibutyl tin dilaurate in butyl acetate was added. The solution was clear and a visual assessment of the viscosity noted that the mixture was slightly thick. The solution was stirred in the dark overnight. After stirring overnight, a visual assessment of the viscosity noted that the mixture was almost a gel.

Preparation of Comparative Film Forming Binder 1

5.2 parts by weight of VPLS 2337® acrylic isocyanate and 4.9 parts by weight of comparative diol A were stirred in 5.95 parts by weight of butyl acetate. 0.05 parts by weight of a 2% solution of dibutyl tin dilaurate in butyl acetate was added. The mixture was clear, and a visual assessment of the viscosity noted that the mixture was slightly thick. The solution was stirred in the dark overnight. After stirring overnight, a visual assessment of the viscosity noted that the mixture was thick.

Preparation of Photoinitiator 1

A mixture of 0.75 parts by weigh of DAROCUR® TPO photoinitiator, 2.25 parts by weight of IRGACURE® 184 photoinitiator and 13 parts by weight of methyl ethyl ketone was stirred.

Preparation of UV Coating Composition A

In a suitable mixing vessel, 2.67 parts by weight of DESMOPHEN® VPLS 2089, 4.00 parts by weight of SR 351 HP®, 4.00 parts by weight of SR 355®, 6.00 parts by weight of DESMOLUX® U 680 H, 10.00 parts by weight of DESMOLUX® 2513, 23.33 parts by weight of DESMOLUX® XP 2654, 15.00 parts by weight of acetone, 11.67 parts by weight of methyl isobutyl ketone, 6.29 parts by weight of methyl amyl ketone, 0.75 parts by weight of DAROCUR® TPO, 2.25 parts by weight of IRGACURE® 184, 13.00 parts by weight of methyl ethyl ketone, 0.20 parts by weight of TINUVIN® 400, 0.20 parts by weight of TINUVIN® 292, 0.20 parts by weight of BYK® 333 and 0.44 parts by weight of butyl acetate was stirred to form UV Coating Composition A, The UV coating composition was used as is.

Preparation of UV Coating Composition 1

parts by weight of film forming binder 1, 20 parts by weight of UV Coating Composition A and 4 parts by weight of photoinitiator 1 was stirred.

Preparation of UV Coating Composition 2

16 parts by weight of film forming binder 2, 20 parts by weight of UV Coating Composition A and 4 parts by weight of photoinitiator 1 was stirred.

Preparation of Comparative UV Coating Composition 1

16 parts by weight of comparative film forming binder 1, 20 parts by weight of UV Coating Composition A and 4 parts by weight of photoinitiator 1 was stirred.

Coating compositions 1 and 2 and Comparative Coating composition 1 was applied to a panel that had previously been coated with GEN clearcoat and sanded with 1500 grit sandpaper. Each of the coating compositions were applied so as to provide a dry film build of about 43 to 45 micrometers (1.7-1.8 mils) and then exposed to UVA radiation using an H&S 400 watts UVA lamp for 3 minutes. Two hours after exposure to UVA radiation, the Fisher hardness is measured as well as the finger scratch rating, gloss and distinctness of image (DOI). The results of the tests are shown in TABLE 1. The finger scratch rating is a subjective test using a rating scale of 1 to 10 that was performed two hours after exposure to the UVA radiation. The test involves attempting to scratch the surface of the coating composition with a finger nail. A rating of 10 means that the surface was not able to be scratched while a rating of 1 means that the surface was very easily scratched.

TABLE 1

| | | | Comparative UV |
|---|---|---|---|
| | UV Coating | UV Coating | Coating |
| | Composition 1 | Composition 2 | Composition 1 |
| After exposure to | dry | dry | dry/sticky |
| UVA radiation | | | |
| Fischer Hardness | 24 | 30 | 9 |
| at 2 hours (n/mm²) | | | |
| DOI (average) | 83 | 75 | 86 |
| Gloss (average) | 80 | 78 | 80 |
| finger scratch | 10 | 10 | 3 |
| rating | | | |
| Fischer Hardness | 25 | 32 | 19 |
| at 2 days (n/mm²) | | | |

It is surprising that the initial hardness of Composition 1 and Composition 2 are significantly higher than that of Comparative Coating Composition 1. The difference between Compositions 1 and 2 and comparative coating composition 1 is the substitution of the poly(trimethylene ether) diol for the diol containing the caprolactone. Both polymers have similar glass transition temperatures but markedly different early hardness. As can be seen from TABLE 1, UV Coating Compositions 1 and 2 had significantly better finger scratch ratings and Fischer hardness at both 2 hours and 2 days when compared to Comparative UV Coating Composition 1. While the distinctness of image was slightly lower, the gloss ratings were nearly identical.

What is claimed is:

1. A coating composition comprising a film forming binder wherein the film forming binder comprises component (A) wherein the component (A) is a polymer having at least one poly(trimethylene ether) repeat unit and in the range of from 1 to 20 ethylenically unsaturated double bonds.

2. The coating composition of claim 1 wherein component (A) consists of the reaction product of a reactant (1) with a reactant (2) to form a molecule having a 1-2 or a 1-2-1 arrangement; and wherein reactant (1) is H₂C═C(R)CO₂H, H₂C═C(R)CO₂—R¹-E, H₂C═C(R)¹-E or a combination thereof;
reactant (2) is HO(CH₂CH₂CH₂O)ₙH, and
wherein R is H or CH₃;
each R¹ is independently a divalent linear alkyl radical having in the range of from 1 to 20 carbon atoms, a divalent branched alkyl radical having in the range of from 3 to 20 carbon atoms, a divalent cycloalkyl radical having in the range of from 5 to 10 carbon atoms, or a divalent radical having both cycloalkyl and linear and/or branched alkyl portions having in the range of from 6 to 20 carbon atoms;
E is —NCO, —CO₂H, epoxy, hydroxyl or amine; and
n is in the range of from 5 to 2,000.

3. The coating composition of claim 1 wherein component (A) comprises the reaction product of reactants (1), (2) and (3) to form a molecule having an arrangement according to;
(1-2)ₐ-(3),
(1)ₐ-(3)-(2)ₐ,
(1-2)ₐ-(3)-(1)ₐ,
(1-2)ₐ-(3)-(2)_{b}, or
(1)ₐ-(3)-(2)-(3)-(1)_{b};
wherein a is in the range of from 1 to 20; and
b is in the range of from 0 to 20; and
wherein reactant (1) is H₂C═C(R)CO₂H, H₂C═C(R)CO₂—R¹-E, H₂C═C(R)—R¹-E or a combination thereof;
reactant (2) is HO(CH₂CH₂CH₂O)ₙH; and
wherein R is H or CH₃;
each R¹ is a divalent linear alkyl radical having in the range of from 1 to 20 carbon atoms, a divalent branched alkyl radical having in the range of from 3 to 20 carbon atoms, a divalent cycloalkyl radical having in the range of from 5 to 10 carbon atoms, or a divalent radical having both cycloalkyl and linear and/or branched alkyl portions having in the range of from 6 to 20 carbon atoms;
E is —NCO, —CO₂H, epoxy, hydroxyl or amine;
n is in the range of from 5 to 2,000; and
reactant (3) is a diisocyanate, a polyisocyanate, dicarboxylic acid, a polycarboxylic acid, a dicarboxylic acid ester, a polycarboxylic acid ester, a diepoxide, a polyepoxide, a polyacrylate having carboxylic acid functional groups, polyacrylate having isocyanate functional groups, a polyacrylate having epoxy functional groups, hexamethylene diisocyanate, isophorone diisocyanate, the isocyanurate of hexamethylene diisocyanate, the isocyanurate of isophorone diisocyanate or a combination thereof.

4. The coating composition of claim 3 wherein component (A) further comprises a reactant (4); wherein reactant (4) is a molecule having in the range of from 2 to 10 functional groups, at least one of the functional groups are reactive with reactant (2) or (3).

5. The coating composition of claim 1 wherein the film forming binder further comprises component (B), component (C) or a combination thereof, wherein component (B) comprises one or more molecules having two or more ethylenically unsaturated groups; and wherein component (C) is a polyisocyanate, a polycarboxylic acid, a polyamine, a polyepoxide or a combination thereof.

6. The coating composition of claim 5 wherein component (B) is hexanediol di(meth)acrylate, trimethylol propane tri(meth)acrylate, pentaerythritol tri(meth)acrylate, pentaerythritol tetra(meth)acrylate, ester (meth)acrylates, urethane (meth)acrylates or a combination thereof.

7. The coating composition of claim 1 wherein the coating composition further comprises in the range of from 1 to 15 percent by weight, based on the weight of the film forming binder of a photoinitiator; and further comprises organic solvent.

8. A method of applying a layer of a coating composition to a substrate, the method comprising the steps of;
1) applying a layer of the coating composition to the substrate;
2) optionally allowing at least a portion of the organic solvent to flash off; and
3) exposing at least a portion of the applied layer of coating composition to radiation to cure at least a portion of the coating composition;
wherein the coating composition comprises a film forming binder wherein the film forming binder comprises component (A) wherein the component (A) is a polymer having at least one poly(trimethylene ether) repeat unit and in the range of from 1 to 20 ethylenically unsaturated double bonds.

9. The method of claim 8 wherein component (A) consists of the reaction product of a reactant (1) with a reactant (2) to form a molecule having a 1-2 or a 1-2-1 arrangement; and wherein reactant (1) is H₂C═C(R)CO₂H, H₂C═C(R)CO₂—R¹-E, H₂C═C(R)—R¹-E or a combination thereof;
reactant (2) is HO(CH₂CH₂CH₂O)ₙH; and
wherein R is H or CH₃;
each R¹ is independently a divalent linear alkyl radical having in the range of from 1 to 20 carbon atoms, a divalent branched alkyl radical having in the range of from 3 to 20 carbon atoms, a divalent cycloalkyl radical having in the range of from 5 to 10 carbon atoms, or a divalent radical having both cycloalkyl and linear and/or branched alkyl portions having in the range of from 6 to 20 carbon atoms;
E is —NCO, —CO₂H, epoxy, hydroxyl or amine; and n is in the range of from 5 to 2,000.

10. The method of claim 8 wherein component (A) comprises the reaction product of reactants (1), (2) and (3) to form a molecule according to;
(1-2)ₐ-(3),
(1)ₐ-(3)-(2)ₐ,
(1-2)ₐ-(3)-(1)_{b},
(1-2)ₐ-(3)-(2)_{b}, or
(1)ₐ-(3)-(2)-(3)-(1)_{b};
wherein a is in the range of from 1 to 20; and
b is in the range of from 0 to 20; and
wherein reactant (1) is H₂C═C(R)CO₂H, H₂C═C(R)CO₂—R¹-E H₂C═C(R)—R¹-E or a combination thereof;
reactant (2) is HO(CH₂CH₂CH₂O)H; and
wherein R is H or CH₃;
each R¹ is a divalent linear alkyl radical having in the range of from 1 to 20 carbon atoms, a divalent branched alkyl radical having in the range of from 3 to 20 carbon atoms, a divalent cycloalkyl radical having in the range of from 5 to 10 carbon atoms, or a divalent radical having both cycloalkyl and linear and/or branched alkyl portions having in the range of from 6 to 20 carbon atoms;
E is —NCO, —CO₂H, epoxy, hydroxyl and amine;
n is in the range of from 5 to 2,000; and
reactant (3) is a diisocyanate, a polyisocyanate, a dicarboxylic acid, a polycarboxylic acid, a dicarboxylic acid ester, a polycarboxylic acid ester, a diepoxide, a polyepoxide, a polyacrylate having carboxylic acid functional groups, a polyacrylate having isocyanate functional groups, a polyacrylate having epoxy functional groups, hexamethylene diisocyanate, isophorone diisocyanate, the isocyanurate of hexamethylene diisocyanate, the isocyanurate of isophorone diisocyanate or a combination thereof.

11. The method of claim 10 wherein component (A) further comprises a reactant (4); wherein reactant (4) is a molecule having in the range of from 2 to 10 functional groups, at least one of the functional groups are reactive with reactant (2) or (3).

12. The method of claim 8 wherein the film forming binder further comprises component (B), component (C) or a combination thereof, wherein component (B) comprises one or more molecules having two or more ethylenically unsaturated groups; and wherein component (C) comprises polyisocyanates, polycarboxylic acids, polyamines, polyepoxides and a combination thereof.

13. The method of claim 12 wherein component (B) is hexanediol di(meth)acrylate, trimethylol propane tri(meth)acrylate, pentaerythritol tri(meth)acrylate, pentaerythritol tetra(meth)acrylate, ester (meth)acrylates, urethane (meth)acrylates and a combination thereof.

14. The method of claim 8 wherein the coating composition further comprises in the range of from 1 to 15 percent by weight, based on the weight of the film forming binder of a photoinitiator; and further comprises organic solvent.

15. A substrate coated by a layer of a dried and cured coating composition wherein the coating composition comprises a film forming binder wherein the film forming binder comprises component (A) wherein the component (A) is a polymer having at least one poly(trimethylene ether) repeat unit and in the range of from 1 to 20 ethylenically unsaturated double bonds.

16. The substrate of claim 15 wherein component (A) consists of the reaction product of a reactant (1) with a reactant (2) to form a molecule having a 1-2 or a 1-2-1 arrangement; and wherein reactant (1) is H₂C═C(R)CO₂H, H₂C═C(R)CO₂—R¹-E, H₂C═C(R)—R¹-E or a combination thereof;
reactant (2) is HO(CH₂CH₂CH₂O)ₙH; and
wherein R is H or CH₃;
each R¹ is a divalent linear alkyl radical having in the range of from 1 to 20 carbon atoms, a divalent branched alkyl radical having in the range of from 3 to 20 carbon atoms, a divalent cycloalkyl radical having in the range of from 5 to 10 carbon atoms, or a divalent radical having both cycloalkyl and linear and/or branched alkyl portions having in the range of from 6 to 20 carbon atoms;
E is —NCO, —CO₂H, epoxy, hydroxyl and amine; and n is in the range of from 5 to 2,000.

17. The substrate of claim 15 wherein component (A) comprises the reaction product of reactants (1), (2) and (3) to form a molecule having an arrangement according to;
(1-2)ₐ-(3),
(1)ₐ-(3)-(2)ₐ,
(1-2)ₐ-(3)-(1)_{b},
(1-2)ₐ-(3)-(2)_{b}, or
(1)ₐ-(3)-(2)-(3)-(1)_{b};
wherein a is in the range of from 1 to 20; and
b is in the range of from 0 to 20; and
wherein reactant (1) is H₂C═C(R)CO₂H, H₂C═C(R)CO₂—R¹-E H₂C═C(R)—R¹-E or a combination thereof;
reactant (2) is HO(CH₂CH₂CH₂O)ₙH; and
wherein R is H or CH₃;
each R¹ is a divalent linear alkyl radical having in the range of from 1 to 20 carbon atoms, a divalent branched alkyl radical having in the range of from 3 to 20 carbon atoms, a divalent cycloalkyl radical having in the range of from 5 to 10 carbon atoms, or a divalent radical having both cycloalkyl and linear and/or branched alkyl portions having in the range of from 6 to 20 carbon atoms;
E is —NCO, —CO₂H, epoxy, hydroxyl and amine;
n is in the range of from 5 to 2,000; and
reactant (3) is a diisocyanate, a polyisocyanate, a dicarboxylic acid, a polycarboxylic acid, a dicarboxylic acid ester, a polycarboxylic acid ester, a diepoxide, a polyepoxide, a polyacrylate having carboxylic acid functional groups, a polyacrylate having isocyanate functional groups, a polyacrylate having epoxy functional groups, hexamethylene diisocyanate, isophorone diisocyanate, the isocyanurate of hexamethylene diisocyanate, the isocyanurate of isophorone diisocyanate or a combination thereof.

18. The substrate of claim 17 wherein component (A) further comprises a reactant (4); wherein reactant (4) is a molecule having in the range of from 2 to 10 functional groups, at least one of the functional groups are reactive with reactant (2) or (3).

19. The substrate of claim 1 wherein the film forming binder further comprises component (B), component (C) or a combination thereof, wherein component (B) comprises one or more molecules having two or more ethylenically unsaturated groups; and wherein component (C) comprises polyisocyanates, polycarboxylic acids, polyamines, polyepoxides and a combination thereof.

20. The substrate of claim 19 wherein component (B) is hexanediol di(meth)acrylate, trimethylol propane tri(meth)acrylate, pentaerythritol tri(meth)acrylate, pentaerythritol tetra(meth)acrylate, ester (meth)acrylates, urethane (meth)acrylates and a combination thereof.

21. The substrate of claim 15 wherein the coating composition further comprises in the range of from 1 to 15 percent by weight, based on the weight of the film forming binder of a photoinitiator and further comprises organic solvent.
